(19) United States
(12) Patent Application Publication
(10) Pub. No.: US 2015/0066381 A1
(43) Pub. Date: Mar. 5, 2015

(54) GENOMIC PIPELINE EDITOR WITH TOOL LOCALIZATION

(71) Applicant: Seven Bridges Genomics Inc., Cambridge, MA (US)

(72) Inventor: Deniz Kural, Somerville, MA (US)

(21) Appl. No.: 14/474,475

(22) Filed: Sep. 2, 2014

Related U.S. Application Data
(60) Provisional application No. 61/873,118, filed on Sep. 3, 2013.

(51) Int. Cl. G06F 19/18

(52) U.S. Cl. CPC G06F 19/18
USPC 702/19

(57) ABSTRACT

The invention provides systems and methods for creating and using genomic analysis pipelines in which each analytical step within the pipeline can be independently set to run in a particular location. Steps that involve patient-identifying information or other sensitive research results can be restricted to running on a computer that is under the user's control, while steps that require a vast amount of processing power to sift through large amounts of raw data can be set to run on a powerful computer system such as a multi-processor server or cloud computer. The system provides a genomic pipeline editor with a plurality of genomic tools that can be arranging into pipelines. For one or more of the tools, the system receives a selection indicating execution by a particular computer. The system will cause genomic data to be analyzed according to the pipeline and the location selection.

### CROSS-REFERENCE TO RELATED APPLICATION

This application claims priority to, and the benefit of, U.S. Provisional Patent Application No. 61/873,118, filed Sep. 3, 2013, the contents of which are incorporated by reference.

### FIELD OF THE INVENTION

The invention generally relates to genomic analysis and systems and methods for creating analytical pipelines in which individual tools run at particular, specified computers.

### BACKGROUND

Contemporary DNA sequencing technologies generate very large amounts of data very rapidly and, as a consequence, genomics is being transformed from a biological science into an information science. Next-generation sequencing (NGS) instruments are affordable and can be found in many hospitals and clinics. However, deriving medically meaningful information from the volumes of data that those instruments generate is not a trivial task. Genomic analysis can be so computationally demanding as to require powerful computer resources such as cloud computing or parallel computing clusters.

Tools exist for analyzing genomic data “in the cloud.” For example, there are companies that offer online sites to which a researcher can upload their genetic data and access online tools for genetic analysis. Unfortunately, the basic paradigm involves copying all the raw genetic data and the medical or research insights represented by that genetic data onto a third-party company's servers, which may then even be copied to servers provided by other companies for additional processing power.

Where a doctor or a researcher wishes to keep key data private and to confine that data to a particular location such as a computer within the clinic or lab, the alternative is to perform the genomic analysis “locally.” Unfortunately, this limits the computational power to that which can be provided locally, restricting the clinic's ability to realize the full potential of NGS sequencers to discover medically significant information among the vast amounts of raw data they generate.

### SUMMARY

The invention provides systems and methods for creating and using genomic analysis pipelines in which each analytical step within the pipeline can be independently set to run in a particular location. Steps that involve patient-identifying information or other sensitive research results can be restricted to running on a computer that is under the user's control, while steps that require a vast amount of processing power to sift through large amounts of raw data can be set to run on a powerful computer system such as a multi-processor server or cloud computer.

The system includes a pipeline editor that a user can use to design a genomic pipeline. The genomic pipeline represents a set of instructions that will advance genomic data through a sequence of analytical operations, with each operation being assigned by the user to execute in a particular location. The pipeline can be stored in a system computer with this location execution information.

The pipeline editor can be presented in an intuitive user interface, such as a “drag and drop” workspace in a web browser or other application. Individual ones of the analytical operations can be presented as individual tools (e.g., represented as clickable icons). Each tool can be presented in the interface with one or more parameters that can be set for that tool. The execution location parameter can be presented within the interface as a button, switch, or similar input (e.g., radio button for “local” or “cloud”). The stored pipeline can be retrieved and executed within the pipeline editor user interface or can be exported as a standalone tool.

When the pipeline is executed, the system computer causes the sequence of analytical operations to be performed in their assigned locations. The system computer can cause the data of the in-progress genomic analysis to be transferred between a particular user computer and an online resource such as a cloud or cluster computer. In this way, the user can cause the analysis to “toggle” between a local desktop computer and the cloud or cluster computer. Additionally, for the steps that are performed on the particular user computer, the sensitive data is restricted to that computer and can be made to reside there exclusively.

In certain aspects, the invention provides a system for genomic analysis that includes a server computer system comprising a processor coupled to a memory. The system is operable to provide a genomic pipeline editor comprising a plurality of genomic tools, receive input arranging the tools into a pipeline, and—for one or more of the tools—receive a selection indicating a particular computer to execute the tool. The system will cause genomic data to be analyzed according to the pipeline and the selection. Analyzing the genomic data includes executing the tool on the particular indicated computer while keeping at least a portion of the genomic data exclusively on the particular indicated computer and executing others of the plurality of genomic tools remotely from the particular computer. In some embodiments, executing a tool on the particular computer includes transferring output from that tool to the server computer system. The system processor itself may execute at least a second one of the plurality of tools, or it may direct execution using other processing resources such as a cloud computing environment. In general, the analysis by the pipeline will involve transferring genomic data back and forth between the particular computer and at least one cloud computer.

In some embodiments, the system can be used to receive, for each of the tools, a user selection indicating execution by the particular computer or execution by a different computer and execute each tool according the selection. The system may be used to provide the genomic pipeline editor by showing the plurality of genomic tools as icons in a graphical user interface (e.g., appearing on a monitor of the user's computer).

Pipelines may be created by one user on one computer and saved to be executed by other users on other computers. To this end, the system is operable to receive the input arranging the tools into the pipeline from a first user using a first client-side computer, provide the pipeline to a second user via a second client-side computer; and cause—responsive to an instruction from the second user—the genomic data to be analyzed according to the pipeline and the selection.

In related aspects, the invention provides methods for genomic analysis. Methods include using a server computer comprising a processor coupled to provide a genomic pipeline editor comprising a plurality of genomic tools, receive input arranging the tools into a pipeline, and—for a first one of the tools—receive a selection indicating a particular computer to execute the tool. The server is used to cause genomic data to be analyzed according to the pipeline and the selection. Analyzing the genomic data is done by using the server computer to cause execution of the first one of the tools on the particular computer while keeping at least a portion of the genomic data exclusively on the particular computer and execution of others of the plurality of genomic tools remotely from the particular computer (e.g., on the server or on an affiliated cloud computing system).

### BRIEF DESCRIPTION OF THE DRAWINGS

FIG. 1 illustrates a pipeline editor according to some embodiments.

FIG. 2 diagrams a system of the invention.

FIG. 3 depicts a tool for use in a pipeline.

FIG. 4 shows a display presented by pipeline editor.

FIG. 5 illustrates a connector connecting two tools in a pipeline.

FIG. 6 shows a pipeline that includes three tools.

FIG. 7 illustrates dragging a tool into the pipeline editor workspace.

FIG. 8 illustrates components of a system of the invention.

FIG. 9 diagrams inter-relation of the components.

FIG. 10 shows a pipeline executing with individual tools in set locations.

FIG. 11 shows a pipeline that includes a private tool.

FIG. 12 shows a pipeline for providing an alignment summary.

FIG. 13 depicts a pipeline for split read alignment.

### DETAILED DESCRIPTION

The invention provides systems and methods by which genomic pipelines can be planned, created, stored, and executed, with individual ones of the tools within the pipelines can be set to run on a particular computer such as the user's local computer or a server. Each tool within the pipeline can have its execution location set independently. When the system executes the pipeline, it causes the data of the in-process analysis to be moved to the appropriate computer at each step and causes each tool to run according to the user's selection.

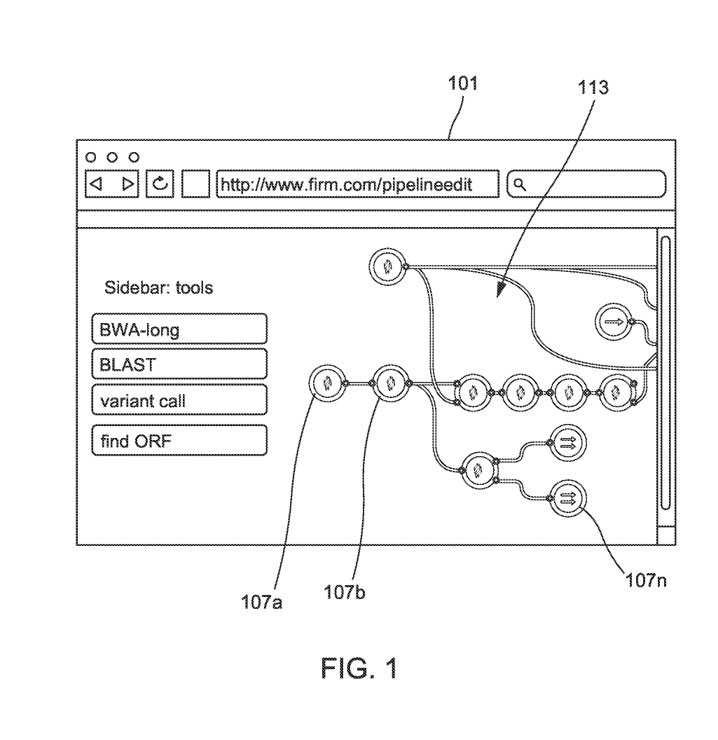

FIG. 1 illustrates a pipeline editor 101 according to some embodiments. Pipeline editor 101 may be presented in any suitable format such as a dedicated computer application or as a web site accessible via a web browser. Generally, pipeline editor 101 will present a work area in which a user can see and access a plurality of tools 107a, 107b, . . . ,107n (e.g., represented as icons). As shown in FIG. 1, each tool 107 is part of a pipeline 113. In general, a tool 107 will have at least one input or output that can be linked to one or more input or output of another tool 107. A set of linked tools may be referred to as a pipeline.

A pipeline generally refers to a bioinformatics workflow that includes one or a plurality of individual steps. Each step (embodied and represented as a tool 107 within pipeline editor 101) generally includes an analysis or process to be performed on genetic data. For example, an analytical project may begin by obtaining a plurality of sequence reads. The pipeline editor 101 can provide the tools to quality control the reads and then to assemble the reads into contigs. The contigs may then be compared to a references, such as the human genome (e.g., hg18) to detect mutations by a third tool. These three tools—quality control, assembly, and compare to reference—as used on the raw sequence reads represent but one of myriad genomic pipelines. As represented in FIG. 1, each step is provided as a tool 107. Any tool 107 may perform any suitable analysis such as, for example, alignment, variant calling, RNA splice modeling, quality control, data processing (e.g., of FASTQ, BAM/SAM, or VCF files), or other formatting or conversion utilities. Pipeline editor 101 represents tools 107 as “apps” and allows a user to assemble tools into a pipeline 113.

Small pipelines can be included that use but a single app, or tool. For example, editor 101 can include a merge FASTQ pipeline that can be re-used in any context to merge FASTQ files. Complex pipelines that include multiple interactions among multiple tools (e.g., such as a pipeline to call variants from single samples using BWA+GATK) can be created to store and reproduce published analyses so that later researchers can replicate the analyses on their own data.

Using the pipeline editor 101, a user can browse stored tools and pipelines to find a stored tool 107 of interest that offers desired functionality. The user can then copy the tool 107 of interest into a project, then run it as-is or modify it to suit the project. Additionally, the user can build new analyses from scratch. Once pipeline 113 is assembled, the invention provides systems and methods for assigning each step of the pipeline to run in a particular location, such as locally or in a cloud environment. Once pipeline 113 is assembled in pipeline editor 101, it provides a ready-to-run bioinformatic analysis workflow.

Embodiments of the invention can include server computer systems that provide pipeline editor 101 as well as computing resources for performing the analyses represented by pipeline 113. Computing execution and storage can be provided by one or more server computers of the system, by an affiliated cloud or cluster resource, by a user's local computer resources, or a combination thereof.

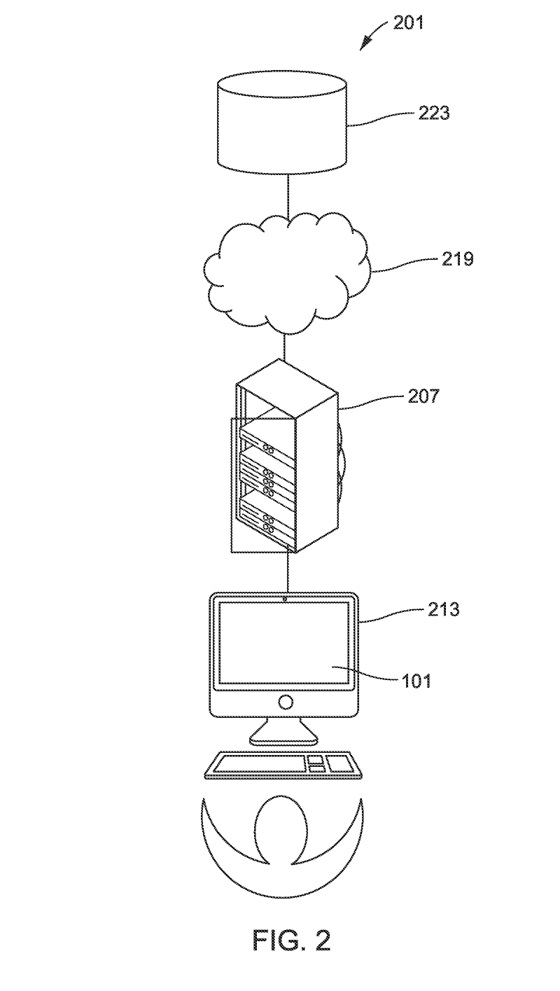

FIG. 2 diagrams a system 201 according to certain embodiments. System 201 generally includes a server computer system 207 to provide functionality such as access to one or more tools 107. A user can access pipeline editor 101 and tools 107 through the use of a local computer 213. A pipeline module on server 207 can invoke the series of tools 107 called by a pipeline 113. A tool module can then invoke the commands or program code called by the tool 107. Commands or program code can be executed by processing resources of server 207. In certain embodiments, processing is provided by an affiliated cloud computing resource 219. Additionally, affiliated storage 223 may be used to store data.

A user can interact with pipeline editor 101 through a local computer 213. Local computer 213 can be any suitable computer such as a laptop, desktop, or mobile device such as a tablet or smartphone. In general, local computer 213 is a computer device that includes a memory coupled to a processor with one or more input/output mechanism. Local computer 213 communicates with server 207, which is generally a computer that includes a memory coupled to a processor with one or more input/output mechanism. These computing devices can optionally communicate with affiliated resource 219 or affiliated storage 223, each of which preferably use and include at least computer comprising a memory coupled to a processor.

A computer generally includes a processor coupled to a memory via a bus. Memory can include RAM or ROM and preferably includes at least one tangible, non-transitory medium storing instructions executable to cause the system to perform functions described herein. As one skilled in the art would recognize as necessary or best-suited for performance of the methods of the invention, systems of the invention include one or more processors (e.g., a central processing unit (CPU), a graphics processing unit (GPU), etc.), computer-readable storage devices (e.g., main memory, static memory, etc.), or combinations thereof which communicate with each other via a bus.

A processor may be any suitable processor known in the art, such as the processor sold under the trademark XEON E7 by Intel (Santa Clara, Calif.) or the processor sold under the trademark OPTERON 6200 by AMD (Sunnyvale, Calif.).

Memory may refer to a computer-readable storage device and can include any machine-readable medium on which is stored one or more sets of instructions (e.g., software embodying any methodology or function found herein), data (e.g., embodying any tangible physical objects such as the genetic sequences found in a patient's chromosomes), or both. While the computer-readable storage device can in an exemplary embodiment be a single medium, the term “computer-readable storage device” should be taken to include a single medium or multiple media (e.g., a centralized or distributed database, and/or associated caches and servers) that store the one or more sets of instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, and any other tangible storage media. Preferably, a computer-readable storage device includes a tangible, non-transitory medium.

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Any suitable services can be used for affiliated resource 219 or affiliated storage 223 such as, for example, Amazon Web Services. In some embodiments, affiliated storage 223 is provided by Amazon Elastic Block Store (Amazon EBS) snapshots, allowing cloud resource 219 to dynamically mount Amazon EBS volumes with the data needed to run pipeline 113. Use of cloud storage 223 allows researchers to analyze data sets that are massive or data sets in which the size of the data set varies greatly and unpredictably. Thus, systems of the invention can be used to analyze, for example, hundreds of whole human genomes at once.

As shown in FIG. 1, within pipeline editor 101, individual tools (e.g., command line tools) are represented as an icon in a graphical editor.

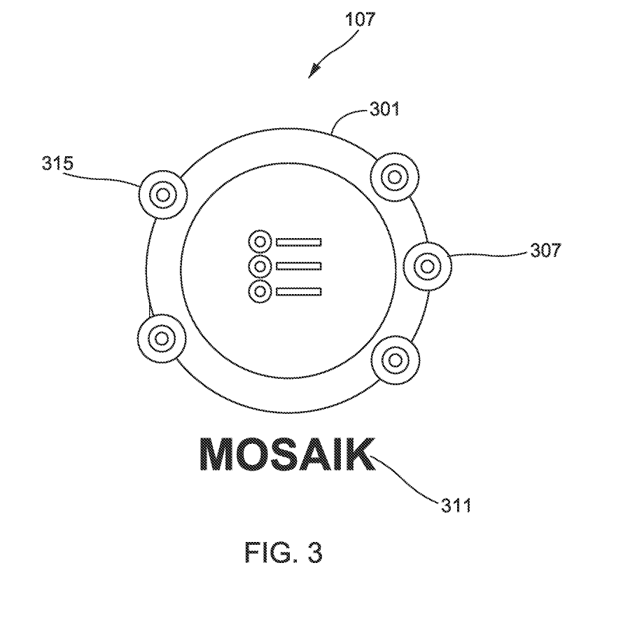

FIG. 3 depicts a tool 107, shown represented as an icon 301. Any icon 301 may have one or more output point 307 and one or more input point 315. In embodiments in which an icon 301 represents an underlying command (such as a UNIX/LINUX command), input point 315 is analogous to an argument that can be piped in and output point 307 represents the output of the command. Icon 301 may be displayed with a label 311 to aid a user in recognizing tool 107. Clicking on the icon 301 for tool 107 allows parameters of the tool to be set within pipeline editor 101.

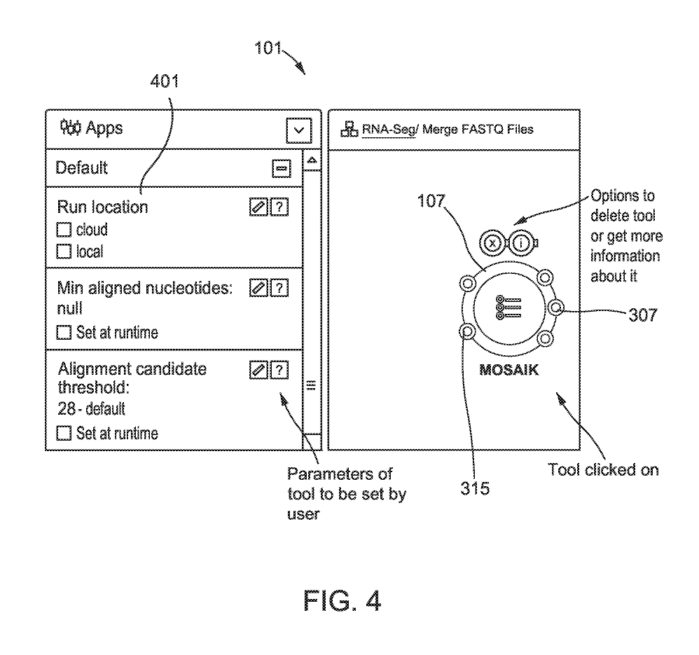

FIG. 4 shows a display presented by pipeline editor 101 when a tool 107 is selected. The tool may include buttons for deleting that tool or getting more information associated with the icon 301. Additionally, a list of parameters for running the tool may be displayed with elements such as tick-boxes or input prompts for setting the parameters (e.g., analogous to switches or flags in UNIX/LINUX commands). Clicking on tool 107 thus allows parameters of the tool to be set within editor 101 (e.g., within a graphical interface). As discussed in more detail below, the parameter settings will then be passed through the tool module to the command-level module. A user may build a pipeline 113 by placing connectors between input points 315 and output points 307.

Among the tool parameters is a setting for indicating at what particular location the tool is to run (e.g., whether the tool is run on the cloud or locally on the user's machine). The setting may be presented as a toggle or similar GUI element. Any suitable element can be used such as check-boxes, text input, or mutually-exclusive radio buttons (e.g., one for “run locally” and one for “run on the cloud”). By these means, the system can receive, for each of the tools, a user selection indicating execution by one or another particular computer. By making reference to the selection, the system can cause the execution of each tool according the selection.

The execution location parameter for each tool gives users the ability to decide to have some parts of the pipeline run locally and others in the cloud. This ability is useful if there is some particular data protection worry with one tool but not others. For example, a clinic may perform a sequencing operation in which raw sequence reads are tracked using only randomized, anonymized codes. After the sequence reads are assembled, the resulting genomic information may be used to identify certain disease-associated genotypes and to prepare a patient report that contains information valuable for genetic counseling. In this example, the assembly can be performed on resource 219 and the genotype calls and patient reporting can all be performed in local computer 213.

As another illustrative example, a researcher may be developing a novel algorithm to generate phylogenetic trees. The research project may entail aligning a plurality of sequences from cytochrome c, using jModelTest to posit an evolutionary model, and then inferring a tree using Bayesian analysis while simultaneously and in parallel inferring a tree using the novel algorithm. The program jModelTest is an updated version of ModelTest, a program discussed in Posada and Crandall, MODEL TEST: testing the model of DNA substitution, Bioinformatics 14 (9):817-8 (1998). Phylogenetic trees can be inferred using a Bayesian analysis by the program MrBayes as discussed in Ronquist, et al., MrBayes 3.2: efficient Bayesian phylogenetic inference and model choice across a large model space, Syst Biol 61 (3):539-42 (2012). In an abundance of caution, the researcher may create a pipeline in which the steps of alignment, model-testing, and Bayesian inference are executed in the cloud, while the novel algorithm is executed locally by a tool in the pipeline that passes a FASTA file to local computer 213 and initiates a command that runs a local binary and finally retrieves the output tree, copying the output tree back to the cloud.

To give yet another example to illustrate the operation of the invention, systems and methods of the invention can be employed to transfer data between a local and remote computer during pipeline processing where, for example, the user expects the server computer to provide greater security. For example, a user may design a pipeline using client computer 213. The pipeline may operate first by obtaining sequence reads from an NGS sequencer at cloud 219. The pipeline may perform the following steps: (1) assemble reads; (2) align reads; (3) manually edit alignment; (4) quality check reads; (5) compare to a reference and call variants; and (6) prepare patient reports. In this example, the raw reads and the quality checked data may be associated with individual patients. However, during assembly, the raw reads may be given a code and may thus be anonymized. The genetic data may remain anonymous until quality-checked sequences are being compared to a reference. In some embodiments, a user may set steps (1), (2), (5), and (6) to be performed on a server computer such as server 207 or cloud 219 and have steps (3) and (4) performed on a local computer 213. This may be one way to make a medical analysis comply with privacy regulations where, for example, the online servers offer a security level that complies with regulations and the anonymized sequences do not need that compliance. A user may prefer doing the manual alignment locally so that time can be spent carefully examining genetic information on-screen regardless of the presence of an internet connection. In this example, the pipeline and server cause the data to be transferred to the appropriate computers for each step.

Thus it can be seen that pipelines can be used to perform a variety of analyses, giving users the ability to control at which computer location each step will be performed. In some embodiments, pipelines are created by arranging icons 301 in editor 101 and connecting the tools, as represented by icons, with connectors.

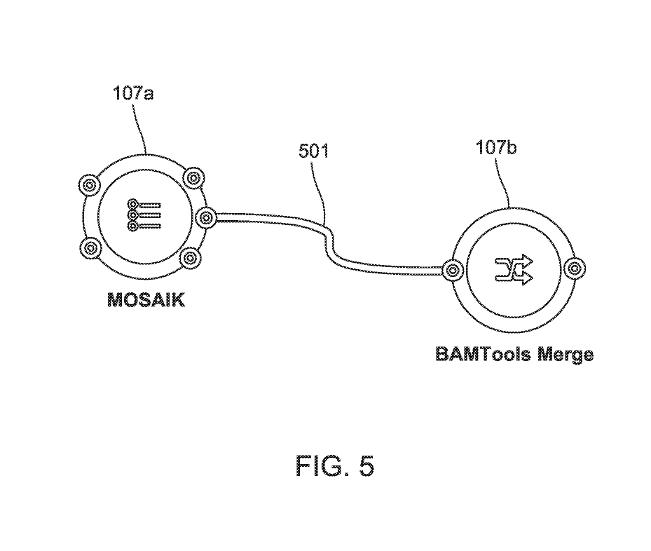

FIG. 5 illustrates a connector 501 connecting a first tool 107a to a second tool 107b. connector 501 represents a data-flow from first tool 107a to second tool 107b (e.g., analogous to the pipe (|) character in UNIX/LINUX text commands).

As discussed above, when a pipeline 113 is built in pipeline editor 101, individual tools within that pipeline may be set to run on a particular computer.

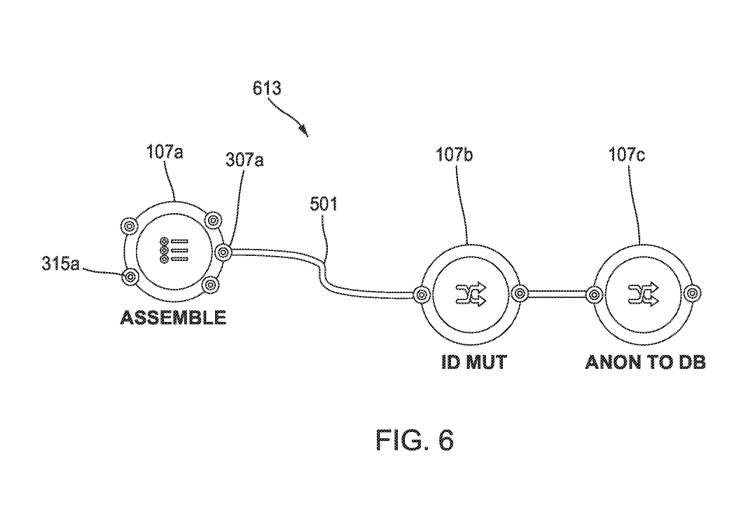

FIG. 6 shows a pipeline 613 having three tools 107: a tool 107a for read assembly, a tool 107b for identifying mutations, and a tool 107c for storing anonymized results in a database. In this example, a user may establish that tools 107a and 107c are to run in the cloud, while tool 107b will run locally. When pipeline 613 is executed, server 207 will transfer sequence reads to cloud 219 for assembly. In this example, assembly includes a de-novo or a reference based assembly or reads into contigs with a full sequence alignment and calling a consensus sequence for each contig. Server 207 then transfers the contigs from cloud 219 to local computer 213. On local computer 213, each contig is compared to a mutation database and mutations are identified (alternatively, each contig can be compared to a reference and variants may be called). A user may see at computer 213 what mutations and genotypes are associated with which patients. In the illustrated pipeline 613, novel mutations that are identified by the identifying step are anonymized. Server 207 then transfers the anonymized results to a database stored in storage 223 for reference in future work.

Each of tools 107a, 107b, and 107c shown in FIG. 6 can be independently set to run on a specified location by the user while the user is creating pipeline 613. Alternatively, a user can load a pre-created pipeline for use and can set the location parameter for each tool within the pipeline.

In this way, system 201 is operable to provide a genomic pipeline editor that includes a plurality of genomic tools, receive input arranging the tools into a pipeline, and—for each of the tools—receive a selection indicating execution by a particular computer. System 201 can then cause genomic data to be analyzed according to the pipeline and the selection. Analyzing the genomic data can include server 207 causing the execution of each tool on the indicated particular computer. For example, a first one of the tools may be executed on the a local computer (such as a doctor's laptop) while keeping at least a portion of the genomic data exclusively on that computer and others of the plurality of genomic tools could be executed remotely from that particular computer. In certain embodiments, the system is operable to automatically perform all of the execution steps upon receiving an instruction from a user (e.g., a user double-clicks on an icon or a pipeline is scheduled to run and once initiated, no further user intervention is called for).

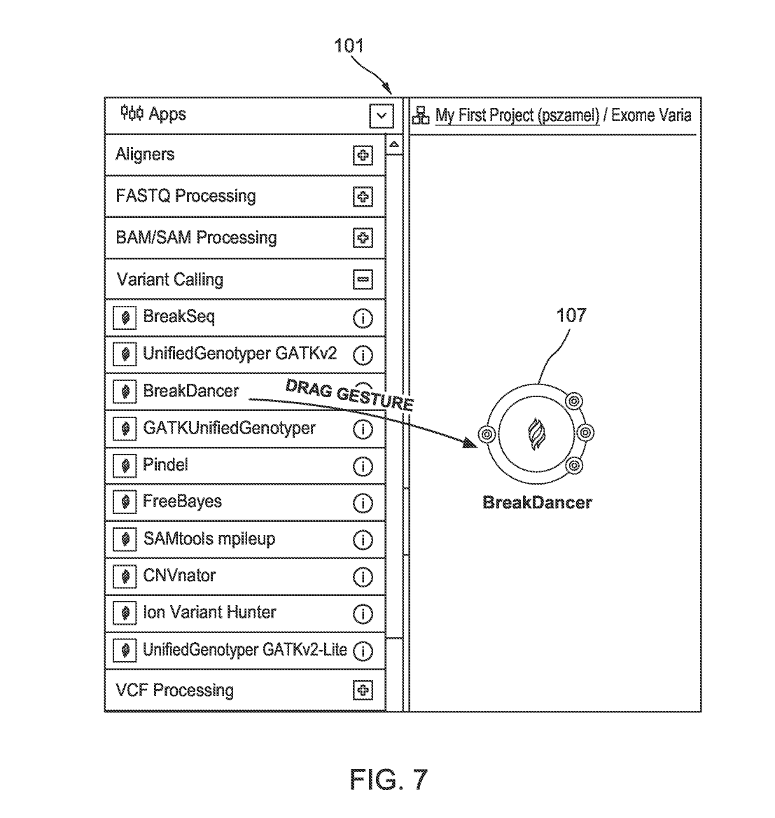

FIG. 7 illustrates how a tool 107 may be brought into pipeline editor 101 for use within the editor. In some embodiments, pipeline editor 101 includes an “apps list” shown in FIGS. 1 and 7 as a column to the left of the workspace in which available tools are listed. In some embodiments, apps on the list can be dragged out into the workspace where they will appear as icons 103.

Systems described herein may be embodied in a client/server architecture. Individual tools described herein may be provided by a computer program application that runs solely on a client computer (i.e., runs locally), solely on a server, or solely in the cloud. A client computer can be a laptop or desktop computer, a portable device such as a tablet or smartphone, or specialized computing hardware such as is associated with a sequencing instrument. For example, in some embodiments, functions described herein are provided by an analytical unit of an NGS sequencing system, operable to perform steps within the NGS system hardware and transfer results from the NGS system to other one or more other computers. In some embodiments, this functionality is provided as a “plug in” or functional component of sequence assembly and reporting software such as, for example, the GS De Novo Assembler, known as gsAssembler or Newbler (NEW assemBLER) from 454 Life Sciences, a Roche Company (Branford, Conn.). Newbler is designed to assemble reads from sequencing systems such as the GS FLX+ from 454 Life Sciences (described, e.g., in Kumar, S. et al., Genomics 11:571 (2010) and Margulies, et al., Nature 437:376-380 (2005)). In some embodiments, pipeline editor 101 is accessible from within a sequence analyzing system such as the HiSeq 2500/1500 system or the Genome AnalyzerIIX system sold by Illumina, Inc. (San Diego, Calif.) (for example, as downloadable content, an upgrade, or a software component).

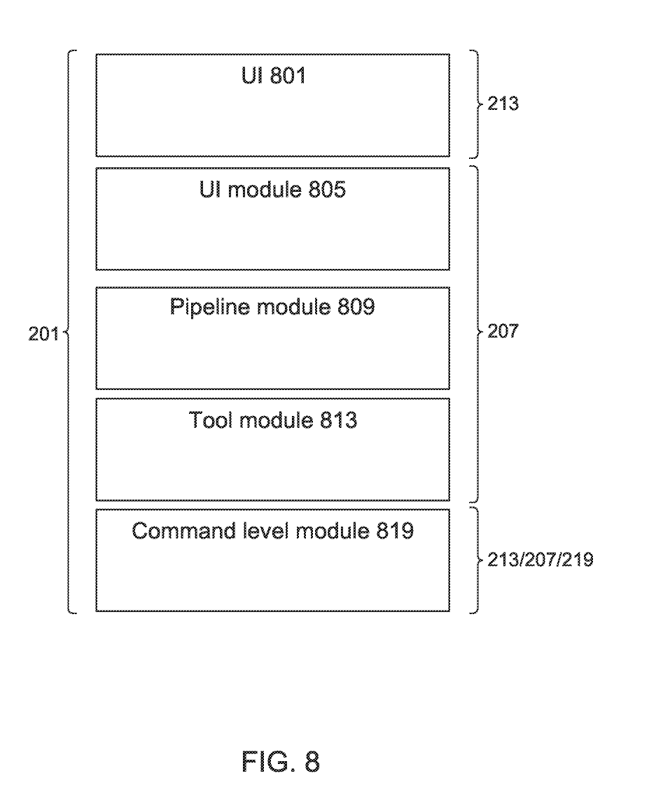

FIG. 8 illustrates components of a system 201 according to certain embodiments. Generally, a user will interact with a user interface (UI) 801 provided within, for example, local computer 213. A UI module 805 may operate within server system 207 to send instructions to and receive input from UI 801. Within server system 207, UI module 805 sits on top of pipeline module 809 which executes pipelines 113. Pipeline module 809 causes a tool module 813 to direct the execution of individual tools 107. Tool module 813 causes the underlying tool commands to be executed by command-level module 819 (e.g., in the cloud or by sending instructions to a local computer). Preferably, UI module 801, pipeline module 809, and tool module 813 are provided at least in part by server system 207. In some embodiments, affiliated cloud computing resource 219 contributes the functionality of one or more of UI module 801, pipeline module 809, and tool module 813. Command-level module 819 may be provided by one or more of local computer 213, server system 207, cloud computing resource 219, or a combination thereof.

Exemplary languages, systems, and development environments that may be used to make and use systems and methods of the invention include Perl, C++, Python, Ruby on Rails, JAVA, Groovy, Grails, Visual Basic .NET. In some embodiments, implementations of the invention provide one or more object-oriented application (e.g., development application, production application, etc.) and underlying databases for use with the applications. An overview of resources useful in the invention is presented in Barnes (Ed.), Bioinformatics for Geneticists: A Bioinformatics Primer for the Analysis of Genetic Data, Wiley, Chichester, West Sussex, England (2007) and Dudley and Butte, A quick guide for developing effective bioinformatics programming skills, PLoS Comput Biol 5 (12):e1000589 (2009).

In some embodiments, systems of the invention are developed in Perl (e.g., optionally using BioPerl). Object-oriented development in Perl is discussed in Tisdall, Mastering Perl for Bioinformatics, O'Reilly & Associates, Inc., Sebastopol, Calif. 2003. In some embodiments, modules are developed using BioPerl, a collection of Perl modules that allows for object-oriented development of bioinformatics applications. BioPerl is available for download from the website of the Comprehensive Perl Archive Network (CPAN). See also Dwyer, Genomic Perl, Cambridge University Press (2003) and Zak, CGI/Perl, 1st Edition, Thomson Learning (2002).

In certain embodiments, systems of the invention are developed using Java and optionally the BioJava collection of objects, developed at EBI/Sanger in 1998 by Matthew Pocock and Thomas Down. BioJava provides an application programming interface (API) and is discussed in Holland, et al., BioJava: an open-source framework for bioinformatics, Bioinformatics 24 (18):2096-2097 (2008). Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008).

Systems of the invention can be developed using the Ruby programming language and optionally BioRuby, Ruby on Rails, or a combination thereof. Ruby or BioRuby can be implemented in Linux, Mac OS X, and Windows as well as, with JRuby, on the Java Virtual Machine, and supports object oriented development. See Metz, Practical Object-Oriented Design in Ruby: An Agile Primer, Addison-Wesley (2012) and Goto, et al., BioRuby: bioinformatics software for the Ruby programming language, Bioinformatics 26 (20):2617-2619 (2010).

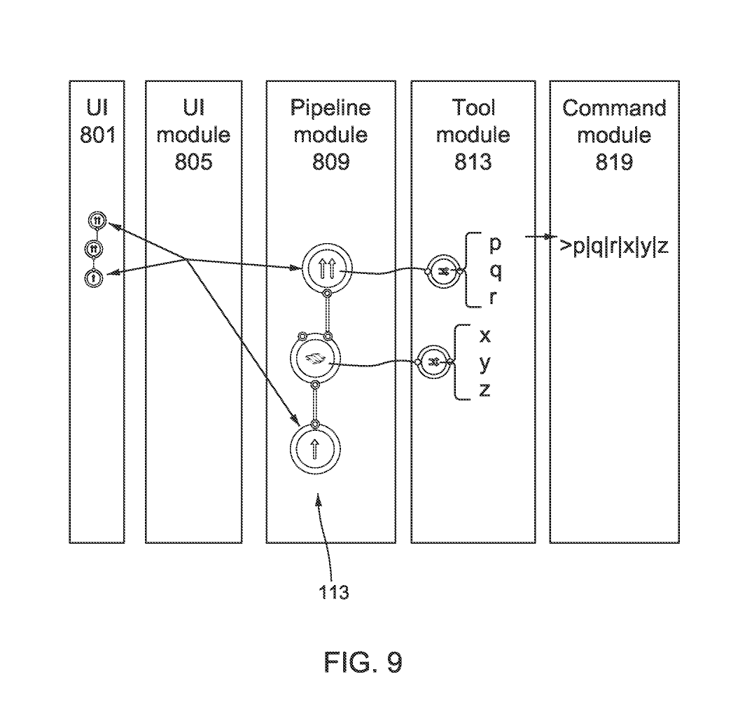

FIG. 9 illustrates the operation and inter-relation of components of systems of the invention. In certain embodiments, a pipeline 113 is stored within pipeline module 809. Pipeline 113 may be represented using any suitable language or format known in the art. In some embodiments, a pipeline is described and stored using JavaScript Object Notation (JSON). The pipeline JSON objects include a section describing nodes (nodes include tools 107 as well as input points 315 and output points 307) and a section describing the relations (i.e., connections 501) between the nodes. Pipeline module 809 may also be the component that executes these pipelines 113.

Tool module 813 manages information about the wrapped tools 107 that make up pipelines 113 (such as inputs/outputs, resource requirements, etc.)

The UI module 805 handles the front-end user interface. This module can represent workflows from pipeline module 809 graphically as pipelines in the graphical pipeline editor 101. The UI module can also represent the tools 107 that make up the nodes in each pipeline 113 as node icons 301 in the graphical editor 101, generating input points 315 and output points 307 and tool parameters from the information in tool module 813. The UI module will list other tools 107 in the “Apps” list along the side of the editor 101, from whence the tools 107 can be dragged and dropped into the pipeline editing space as node icons 301.

In certain embodiments, UI module 805, in addition to listing tools 107 in the “Apps” list, will also list other pipelines the user has access to (e.g., separated into “Public Pipelines” and “Your Custom Pipelines”), getting this information from pipeline module 809. The pipelines can be dragged and dropped into the editing space where they show up as nodes just like tools 107. The input points 315 and output points 307 for these pipelines-as-tools are generated by UI module 805 from the input and output file-nodes in the pipeline being represented (this information is in the workflow JSON). The parameters displayed for the pipeline-as-tool are the parameters of the underlying tools (which UI module 805 can fetch from tool module 813). The UI module 805 can split the parameters into different categories for the different tools in the sidebar of the pipeline editor 101.

When a user stores/saves a pipeline 113 that includes location execution settings for each constituent tool, the location execution settings of the individual tools are pasted into the workflow of the overall pipeline the user is saving. Any data transfers necessary to perform the analyses at the set location are coded for and instructed by instructions associated with the connections between nodes. The connections that require a transfer can have a tag added to them in the JSON to let the system know that data and necessary instructions (e.g., a binary or browser executable code) should be transferred to the identified location.

Using systems described herein, a wide variety of genomic analytical pipelines may be provided. In general, pipelines will relate to analyzing genetic sequence data. The variety of pipelines that can be created is open-ended and unlimited.

To illustrate the breadth of possible analyses that can be supported using system 201 and to introduce a few exemplary pipelines that may be included for use within a system of the invention, a few example pipelines are discussed.

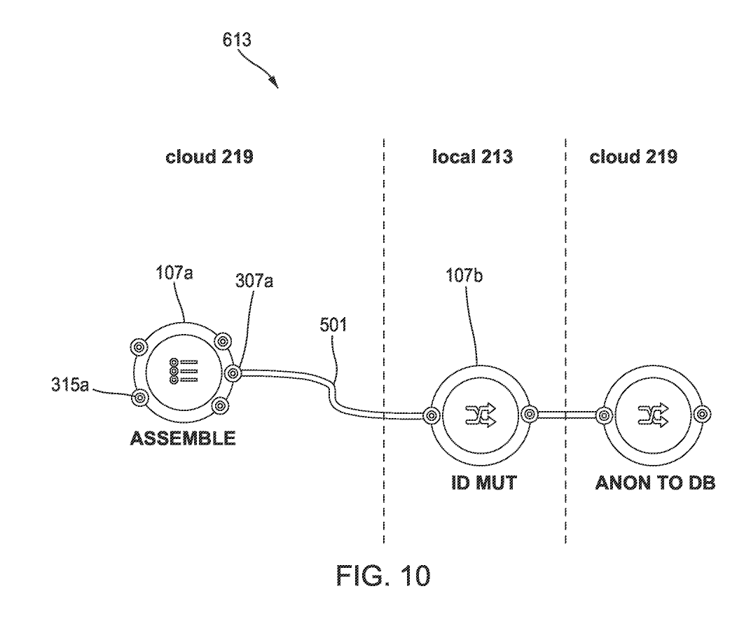

FIG. 10 illustrates pipeline 613 executing with individual tools in set locations. The assemble tool 107a executes in cloud 219. The assembled data is passed to local computer 213. The assembled data is used by local computer 213 to identify mutations. Local computer 213 can then anonymized results for inclusion in a production database. The anonymized results are then transferred to cloud 219 where they are integrated into the database.

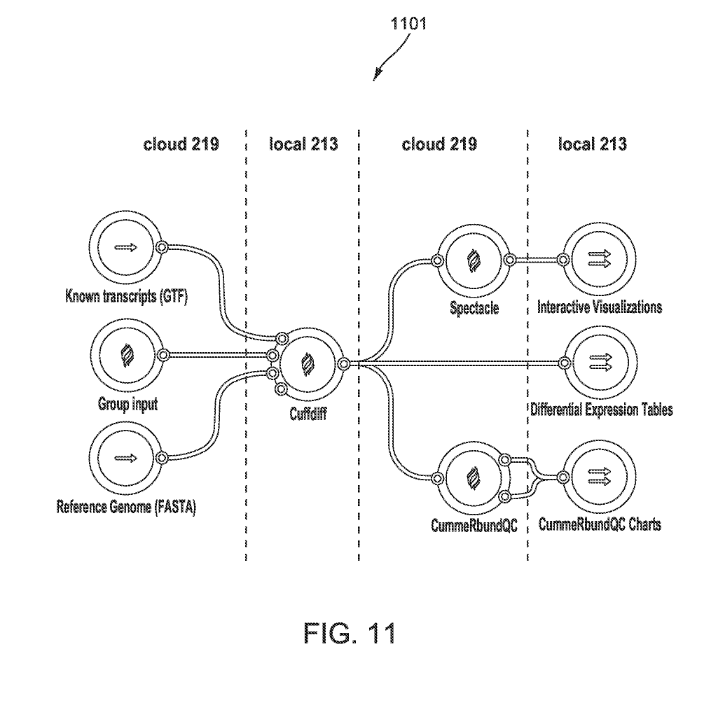

FIG. 11 shows a pipeline 1101 for genomic analysis in which a key analytical tool is kept private and only run locally. In pipeline 1101, private tool 107p accepts read alignment files that have been prepared on cloud 219. The analysis is performed by private tool 107p on local computer 213 and the results are passed back to cloud 219 to quality-check the data and to re-format the data for visual presentation. As shown in FIG. 11, the quality check results and the re-formatted data are passed back to local computer 213 (which may be as a matter of convenience for a researcher if, for example, the researcher wants to generate publication-quality visualizations while working on a private laptop). The local computer 213 then executes the final tools, as initiated by server 207, to prepare visualizations and quality charts.

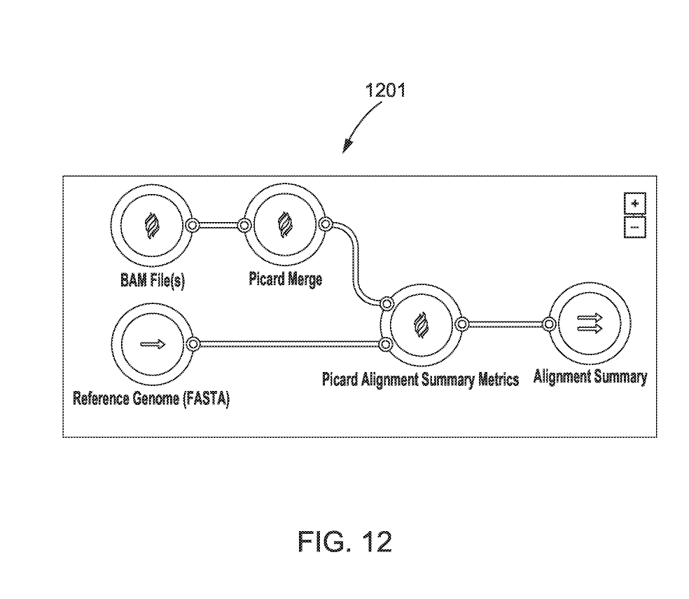

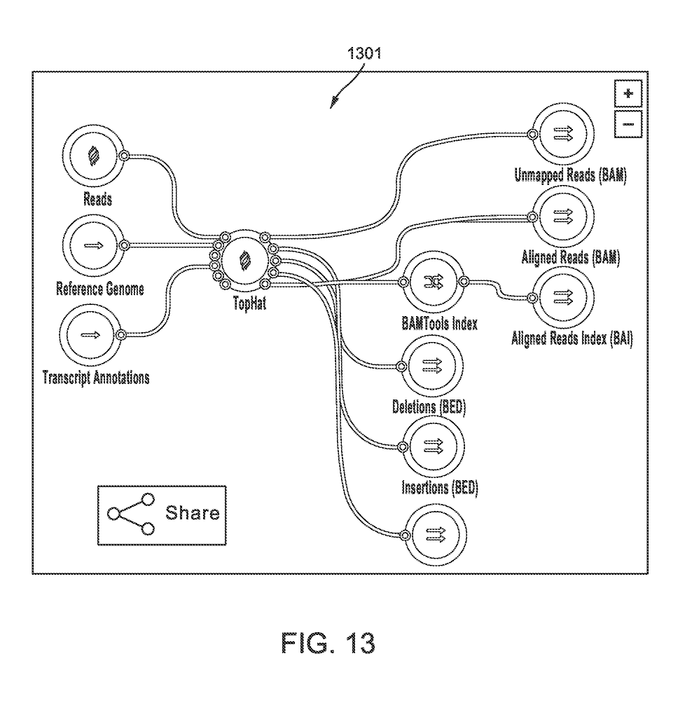

Systems of the invention can be operated to perform a wide variety of analyses. To illustrate the breadth of possible examples, more pipelines are here discussed with respect to FIGS. 12 and 13 and also in the text following that discussion. These examples are not limiting and meant merely to aid the reader in imaging the variety of possible pipeline that can be included. For each step in each pipeline, a user makes a selection indicating that the system 201 should execute that tool in a particular computer. Thus, server 207 is operable to receive, for each of the tools, a user selection indicating execution by the particular computer or execution by a different computer and cause the execution of each tool according the selection.

FIG. 12 shows a pipeline 1201 for providing an alignment summary. Pipeline 1201 can be used to analyze the quality of read alignment for both genomic and transcriptomic experiments. Pipeline 1201 gives useful statistics to help judge the quality of an alignment. Pipeline 1201 takes aligned reads in BAM format and a reference FASTA to which they were aligned as input, and provides a report with information such as the proportion of reads that could not be aligned and the percentage of reads passed quality checks.

FIG. 13 depicts a pipeline 1301 for split read alignment. Pipeline 1301 uses the TopHat aligner to map sequence reads to a reference transcriptome and identify novel splice junctions. The TopHat aligner is discussed in Trapnell, et al., TopHat: discovering splice junctions with RNA-Seq. Bioinformatics 2009, 25:1105-1111, incorporated by reference. Pipeline 1301 accommodates the most common experimental designs. The TopHat tool is highly versatile and the pipeline editor 101 allows a researcher to build pipelines to exploit its many functions.

Other possible pipelines can be created or included with systems of the invention. For example, a pipeline can be provided for exome variant calling using BWA and GATK.

An exome variant calling pipeline using BWA and GATK can be used for analyzing data from exome sequencing experiments. It replicates the default bioinformatic pipeline used by the Broad Institute and the 1000 Genomes Project. GATK is discussed in McKenna, et al., 2010, The Genome Analysis Toolkit: a MapReduce framework for analyzing next-generation DNA sequencing data, Genome Res. 20:1297-303 and in DePristo, et al., 2011, A framework for variation discovery and genotyping using next-generation DNA sequencing data, Nature Genetics. 43:491-498, the contents of both of which are incorporated by reference. The exome variant calling pipeline can be used to align sequence read files to a reference genome and identify single nucleotide polymorphisms (SNPs) and short insertions and deletions (indels).

Other pipelines that can be included in systems of the invention illustrate the range and versatility of genomic analysis that can be performed using system 201. System 201 can include pipelines that: assess the quality of raw sequencing reads using the FastQC tool; align FASTQ sequencing read files to a reference genome and identify single nucleotide polymorphisms (SNPs); assess the quality of exome sequencing library preparation and also optionally calculate and visualize coverage statistics; analyze exome sequencing data produced by Ion Torrent sequencing machines; merge multiple FASTQ files into a single FASTQ file; read from FASTQ files generated by the Ion Proton, based on the two step alignment method for Ion Proton transcriptome data; other; or any combination of any tool or pipeline discussed herein.

The invention provides systems and methods for specifying execution locations for tools within a pipeline editor. Any suitable method of creating and managing the tools can be used. In some embodiments, a software development kit (SDK) is provided. In certain embodiments, a system of the invention includes a Python SDK. An SDK may be optimized to provide straightforward wrapping, testing, and integration of tools into scalable Apps. The system may include a map-reduce-like framework to allow for parallel processing integration of tools that do not support parallelization natively. Pipeline tools suitable for modification for use with systems of the invention are discussed in Durham, et al., EGene: a configurable pipeline system for automated sequence analysis, Bioinformatics 21 (12):2812-2813 (2005); Yu, et al., A tool for creating and parallelizing bioinformatics pipelines, DOD High Performance Computing Conf., 417-420 (2007); Hoon, et al., Biopipe: A flexible framework for protocol-based bioinformatics analysis, Genome Research 13 (8):1904-1915 (2003); International Patent Application Publication WO 2010/010992 to Korea Research Institute of Science and Technology; U.S. Pat. No. 8,146,099; and U.S. Pat. No. 7,620,800, the contents of each of which are incorporated by reference.

Apps can either be released across the platform or deployed privately for a user group to deploy within their tasks. Custom pipelines can be kept private within a chosen user group.

Systems of the invention can include tools for security and privacy. System 201 can be used to treat data as private and the property of a user or affiliated group. The system can be configured so that even system administrators cannot access data without permission of the owner. In certain embodiments, the security of pipeline editor 101 is provided by a comprehensive encryption and authentication framework, including HTTPS-only web access, SSL-only data transfer, Signed URL data access, Services authentication, TrueCrypt support, SSL-only services access, or a combination thereof.

Additionally, systems of the invention can be provided to include reference data. Any suitable genomic data may be stored for use within the system. Examples include: the latest builds of the human genome and other popular model organisms; up-to-date reference SNPs from dbSNP; gold standard indels from the 1000 Genomes Project and the Broad Institute; exome capture kit annotations from IIlumina, Agilent, Nimblegen, and Ion Torrent; transcript annotations; small test data for experimenting with pipelines (e.g., for new users).

In some embodiments, reference data is made available within the context of a database included in the system. Any suitable database structure may be used including relational databases, object-oriented databases, and others. In some embodiments, reference data is stored in a relational database such as a “not-only SQL” (NoSQL) database. In certain embodiments, a graph database is included within systems of the invention.

Using a relational database such as a NoSQL database allows real world information to be modeled with fidelity and allows complexity to be represented.

A graph database such as, for example, Neo4j, can be included to build upon a graph model. Labeled nodes (for informational entities) are connected via directed, typed relationships. Both nodes and relationships may hold arbitrary properties (key-value pairs). There need not be any rigid schema, and node-labels and relationship-types can encode any amount and type of meta-data. Graphs can be imported into and exported out of a graph data base and the relationships depicted in the graph can be treated as records in the database. This allows nodes and the connections between them to be navigated and referenced in real time (i.e., where some prior art many-JOIN SQL-queries in a relational database are associated with an exponential slowdown).

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for genomic analysis, the system comprising:
a server computer system comprising a processor coupled to a memory operable to cause the system to:
provide a genomic pipeline editor comprising a plurality of genomic tools;
receive input arranging the tools into a pipeline;
receive a selection that indicates a particular computer to execute a first one of the tools; and
cause genomic data to be analyzed according to the pipeline and the selection, wherein analyzing the genomic data comprises executing the first one of the tools on the particular computer while keeping at least a portion of the genomic data exclusively on the particular computer and executing others of the plurality of genomic tools remotely from the particular computer.

2. The system of claim 1, wherein executing the first one of the tools on the particular computer comprises:
transferring output from the first one of the tools to the server computer system.

3. The system of claim 1, wherein executing others of the plurality of genomic tools remotely comprises instructing at least one cloud computer to operate.

4. The system of claim 1, wherein executing others of the plurality of genomic tools remotely comprises executing at least a second one of the plurality of tools using the processor.

5. The system of claim 1, wherein causing the genomic data to be analyzed comprises transferring genomic data back and forth between the particular computer and at least one cloud computer.

6. The system of claim 1, further operable to:
receive, for each of the tools, a user selection indicating execution by the particular computer or execution by a different computer; and
execute each tool according the selection.

7. The system of claim 6, wherein executing by the different computer comprises use of a cloud computing system.

8. The system of claim 1, wherein providing the genomic pipeline editor comprises showing the plurality of genomic tools as icons in a graphical user interface.

9. The system of claim 8, wherein the graphical user interface is provided by the particular computer.

10. The system of claim 1, further operable to:
receive the input arranging the tools into the pipeline from a first user using a first client-side computer;
provide the pipeline to a second user via a second client-side computer; and
cause, responsive to an instruction from the second user, the genomic data to be analyzed according to the pipeline and the selection.

11. A method for genomic analysis, the method comprising:
using a server computer comprising a processor coupled to:
provide a genomic pipeline editor comprising a plurality of genomic tools;
receive input arranging the tools into a pipeline;
receive a selection indicating a particular computer to execute a first one of the tools; and
cause genomic data to be analyzed according to the pipeline and the selection, wherein analyzing the genomic data comprises executing the first one of the tools on the particular computer while keeping at least a portion of the genomic data exclusively on the particular computer and executing others of the plurality of genomic tools remotely from the particular computer.

12. The method of claim 11, wherein executing the first one of the tools on the particular computer comprises:
transferring output from the first one of the tools to the server computer method.

13. The method of claim 11, wherein executing others of the plurality of genomic tools remotely comprises instructing at least one cloud computer to operate.

14. The method of claim 11, wherein executing others of the plurality of genomic tools remotely comprises executing at least a second one of the plurality of tools using the processor.

15. The method of claim 11, wherein causing the genomic data to be analyzed comprises transferring genomic data back and forth between the particular computer and at least one cloud computer.

16. The method of claim 11, further comprising using the server computer to:
receive, for each of the tools, a user selection indicating execution by the particular computer or execution by a different computer; and
execute each tool according the selection.

17. The method of claim 16, wherein executing by the different computer comprises use of a cloud computing system.

18. The method of claim 11, wherein providing the genomic pipeline editor comprises showing the plurality of genomic tools as icons in a graphical user interface.

19. The method of claim 18, wherein the graphical user interface is provided by the particular computer.
